(19) United States
(12) Patent Application Publication
(10) Pub. No.: US 2022/0075378 A1
(43) Pub. Date: Mar. 10, 2022

(54) AIRCRAFT-BASED VISUAL-INERTIAL ODOMETRY WITH RANGE MEASUREMENT FOR DRIFT REDUCTION

(71) Applicant: CALIFORNIA INSTITUTE OF TECHNOLOGY, Pasadena, CA (US)

(72) Inventors: Robert A Hewitt, Pasadena, CA (US); Jacob Izraelevitz, Pasadena, CA (US); Donald F Ruffatto, Pasadena, CA (US); Luis Phillipe C.F. Tosi, Los Angeles, CA (US); Matthew Gildner, Los Angeles, CA (US); Gene B Merewether, Pasadena, CA (US)

(21) Appl. No.: 17/352,798

(22) Filed: Jun. 21, 2021

Related U.S. Application Data
(60) Provisional application No. 63/042,937, filed on Jun. 23, 2020.

(51) Int. Cl. G05D 1/00; G05D 1/10; G01N 21/954; B64B 1/22; B64B 1/36

(52) U.S. Cl. CPC G05D 1/0094; G05D 1/101; B64B 1/36; B64B 1/22; G01N 21/954

(57) ABSTRACT

Systems and methods for visual inspection of a container such as an oil tank via a lighter-than-air aircraft are presented. According to one aspect, the aircraft includes a gondola attached to a balloon filled with lighter-than-air gas. Rigidly attached to the gondola is a suite of sensors, including a camera sensor, an inertial measurement unit and a range sensor. Navigation of the aircraft is based on information sensed by the suite of sensors and processed by control electronics arranged in the gondola. Embedded in the control electronics is an extended Kalman filter that calculates pose estimates of the aircraft based on the information sensed by the inertial measurement unit and updated by the camera sensor. The extended Kalman filter uses the information sensed by the range sensor to reduce uncertainty in the calculated pose estimate. Images captured by the camera sensor can be used to evaluate state of the container.

### CROSS REFERENCE TO RELATED APPLICATIONS

The present application claims priority to and the benefit of co-pending U.S. provisional patent application Ser. No. 63/042,937 entitled “State Estimation Software Using Visual-Inertial Odometry with Range Measurement Updates for Drift Reduction”, filed on Jun. 23, 2020, the disclosure of which is incorporated herein by reference in its entirety.

### STATEMENT OF GOVERNMENT INTEREST

This invention was made with government support under Grant No. 80NMO0018D0004 awarded by NASA (JPL). The government has certain rights in the invention.

### TECHNICAL FIELD

The present disclosure generally relates to systems and methods for visual inspection of containers such as oil tanks, in particular, autonomous inspection via a lighter-than-air aircraft.

### BACKGROUND

Offshore oil tanks must be inspected annually for defects to ensure they remain safe to use over their lifetime. To do this the tanks are taken offline for cleaning, followed by approximately twelve human inspectors inspecting the tank over a two weeks period.

Automating such inspection may allow reducing cost associated with required manpower and improving inspection quality with localized high-resolution images taken across the entire tank. Environment inside of an oil tank may render automation via an aircraft challenging, as the aircraft may be required to safely operate in a completely dark and potentially explosive environment. Furthermore, as the oil tank may shield the environment inside of the oil tank, the aircraft may be required to navigate inside of the completely dark oil tank without the help of any external reference signal or beacon, whether a visual target or a transmitted signal (e.g., GPS).

Teachings according to the present disclosure overcome the above challenges via a low power lighter-than-air aircraft with a navigation system that is based on an algorithm that fuses visual-inertial odometry with range measurement.

### SUMMARY

Although the present systems and methods are described with reference to inspection and navigation inside of a container such as an oil tank, such systems and methods may equally apply to other confined or open environments that may be completely dark or include repeating and similar looking terrain, and isolated from guiding signals or beacons, such as, for example, outer space or subterranean/glacier caves. Furthermore, although traditionally interior inspection of a container such as an oil tank is performed in an empty state of the tank (e.g., oil dispensed), the present systems and methods may equally apply to inspection of oil tank while not empty.

According to one embodiment the present disclosure, a system for visual inspection of an inside of a container is presented, the system comprising: a reference range sensor arranged at a fixed location inside of the container; and an aircraft configured for traversal through a trajectory inside of the container, the aircraft comprising a gondola attached to a balloon that is filled with a lighter-than-air gas, the gondola comprising: a camera sensor; an inertial measurement unit (IMU) sensor; a gondola range sensor configured to be in communication with the reference range sensor, the gondola range sensor configured to sense an absolute distance between the gondola range sensor and the reference range sensor; and control electronics configured to calculate a pose estimate of the aircraft during the traversal of the trajectory based on information sensed by the camera sensor and the IMU sensor, and further based on the absolute distance between the gondola range sensor and the reference range sensor.

According to a second embodiment of the present disclosure, a system for pose estimation of an aircraft configured to navigate in a dark environment is presented, the system comprising: a camera sensor; an inertial measurement unit (IMU) sensor; a system range sensor; and control electronics configured to: calculate a pose estimate of the aircraft based on information sensed by the camera sensor and the IMU sensor, and correct the pose estimate based on an absolute range sensed by the system range sensor.

According to a third embodiment of the present disclosure, an aircraft configured for traversal through a trajectory inside of a container is presented, the aircraft comprising a gondola attached to a balloon that is filled with a lighter-than-air gas, the gondola comprising: a camera sensor; an inertial measurement unit (IMU) sensor; a gondola range sensor configured to be in communication with a reference range sensor external to the aircraft, the reference range sensor configured to sense an absolute distance between the gondola range sensor and the reference range sensor; and control electronics configured to calculate a pose estimate of the aircraft during the traversal of the trajectory based on information sensed by the camera sensor and the IMU sensor, and further based on an absolute distance between the gondola range sensor and the reference range sensor.

According to a fourth embodiment of the present disclosure, a method for visual inspection of an inside of a container is presented, the method comprising: providing a reference range sensor at a fixed location inside of the container; and providing an aircraft comprising a gondola attached to a balloon that is filled with a lighter-than-air gas; attaching a camera sensor to the gondola; attaching an inertial measurement unit (IMU) sensor to the gondola; attaching a gondola range sensor to the gondola, the gondola range sensor in communication with the reference range sensor for sensing an absolute distance between the gondola range sensor and the reference range sensor; calculating a pose estimate of the aircraft based on information sensed by the camera sensor and the IMU sensor; and correcting the pose estimate based on the sensed absolute distance between the gondola range sensor and the reference range sensor.

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1A shows an aircraft according to an embodiment of the present disclosure that may be used for inspection of a container such as an oil tank, the aircraft comprising a balloon and a gondola.

FIG. 1B shows details of the gondola of the aircraft of FIG. 1A.

FIG. 2 shows a block diagram of a visual-inertial odometry system that may be used for pose estimation of the aircraft of FIG. 1A.

FIG. 3 shows a diagram depicting uncertainty in location provided by the visual-inertial odometry system of FIG. 2.

FIG. 4 shows a block diagram of a visual-inertial odometry system with range measurement according to an embodiment of the present disclosure that may be used for pose estimation of the aircraft of FIG. 1A.

FIG. 5 shows a diagram depicting uncertainty in location provided by the visual-inertial system with range measurement of FIG. 4.

FIGS. 6A and 6B show relative performance in pose estimation between the systems of FIG. 3 and FIG. 5.

FIG. 7 shows a block diagram of a visual-inertial odometry system with range measurement according to an embodiment of the present disclosure based on the block diagram of FIG. 4 with an added initialization step for derivation of a global reference frame.

Like reference numbers and designations in the various drawings indicate like elements.

### DETAILED DESCRIPTION

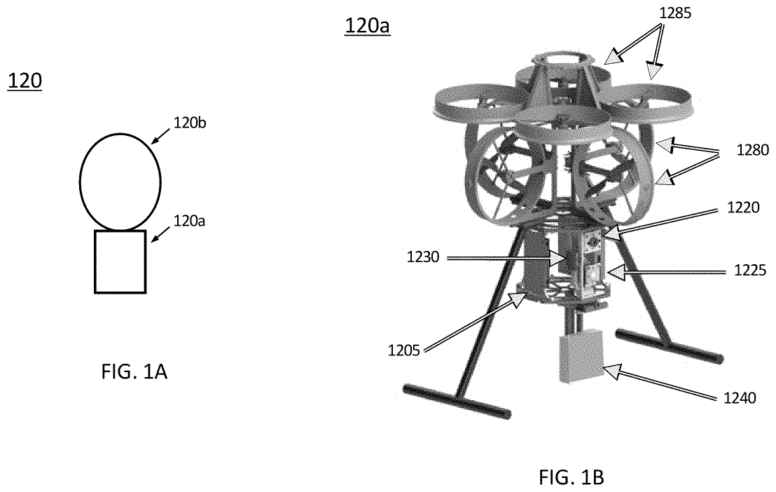

FIG. 1A shows a lighter-than-air aircraft (120) according to an embodiment of the present disclosure that may be used for inspection of a container such as an oil tank. The aircraft (120) comprises a gondola (120a) that is attached to a balloon (120b). The balloon (120b) may be filled with a gas that is less dense than air (e.g., helium or other) inside of the container, thereby providing some lift to the aircraft (120). Due to its relatively light weight and assisted lift from the balloon (120b), the aircraft (120) may be able to safely operate inside of the container with relatively low power.

FIG. 1B shows some details of the gondola (120a), including thrusters (1280, 1285) that may be used to control flight direction of the aircraft (120). According to an embodiment of the present disclosure, the thrusters (1280, 1285) may include propeller thrusters arranged to provide linear thrust according to different directions. For example, thrusters (1285, e.g., four) may provide linear thrust according to an axial/longitudinal direction of the gondola (120a) to control lift of the aircraft (120), whereas the thrusters (1280, e.g., four) may provide linear thrust according to different angular directions of the gondola (120a) such as to control rotation of the aircraft (120).

With continued reference to FIG. 1B, according to an embodiment of the present disclosure, the gondola (120a) may further include sensors that may be used for estimation of location/position and orientation (i.e., pose) of the aircraft (120) within the container (e.g. oil tank). As shown in FIG. 1B, such sensors may include a (machine vision) camera (camera sensor, 1220) that may be assisted by a light source (1225, e.g., LED light), an inertial measurement unit (IMU sensor, 1230) arranged at close proximity to the camera sensor (1220), and an ultra-wideband (UWB) radio transmitter/receiver (range sensor, 1240). The sensors (1220, 1230, 1240) are rigidly coupled to a frame (1205) of the gondola (120a) to establish a fix relative position and orientation with respect to one another, whereas a central optical axis within a field of view of the camera sensor (1220) may be used as a reference to the orientation of the gondola (120a), and therefore of the aircraft (120). Although not shown in the details of FIG. 1B, further elements may be included in the frame (1205) of the gondola (120a), including, for example, autonomous power supply (e.g., batteries) and control electronics so that, in combination with the suite of sensors (1220, 1230, 1240) autonomous navigation and inspection of the inside of the container may be allowed.

According to an embodiment of the present disclosure, the camera sensor (1220) and the IMU sensor (1230) may be used in combination (e.g., fused) to provide a visual-inertial odometry system of the aircraft (120). In other words, information sensed by the camera sensor (1220) and the IMU sensor (1230) may be combined to estimate position and orientation (also called “pose” throughout the present disclosure) of the aircraft (120, e.g., gondola 120a). Furthermore, information sensed by the range sensor (1240) may be used to reduce an error in the estimated pose (e.g., estimated position component of the pose) provided by the combination of the camera sensor (1220) and the IMU sensor (1230).

The information sensed by the camera sensor (1220) may include a time of travel in a given direction, and a change in the direction of the travel (e.g., trajectory, including observations of linear and angular displacement), of the aircraft (120) based on relative movement of features in a sequence of consecutive frames/images captured by the camera sensor (1220) assisted by the light source (1225). Such features, a priori unknown, may include slight changes in pixel intensity (e.g., image texture) in the sequence of captured images that may be in view of random features on the inside walls of the container or other detectable artifacts inside of the container. Software algorithms embedded in the control electronics of the gondola (120a) may be used for detection and tracking of the features.

As the information sensed by the camera sensor (1220) may not include a scale, fusing of such information with information from the IMU sensor (1230, e.g., observed acceleration and rotational rate) may allow scaling of the trajectory sensed by the camera sensor (1220). In other words, the information sensed by the IMU sensor (1230) may be used to provide, for example, acceleration, velocity, and angular rate of the aircraft (120) during traversal of the trajectory described by the camera sensor (1220). Furthermore, such information may be used to provide a position of the aircraft (120) relative to a (global) reference frame (e.g., reference pose).

The visual-inertial odometry system provided by the combination of the camera sensor (1220) and the IMU sensor (1230) may be prone to relatively large (cumulative) errors (e.g., uncertainty in pose estimation, drift) due to, for example, relatively low rate of updates from the camera-based sensor in view of the relatively low power consumption imposed on the control electronics which may limit computational power/speed of embedded algorithms for features detection/tracking, and/or relatively low number of features detectable in the dark and/or present inside of the container. Teachings according to the present disclosure may further enhance accuracy in pose estimate provided by fusion of the camera sensor (1220) and the IMU sensor (1230) by further fusing information sensed by the range sensor (1240).

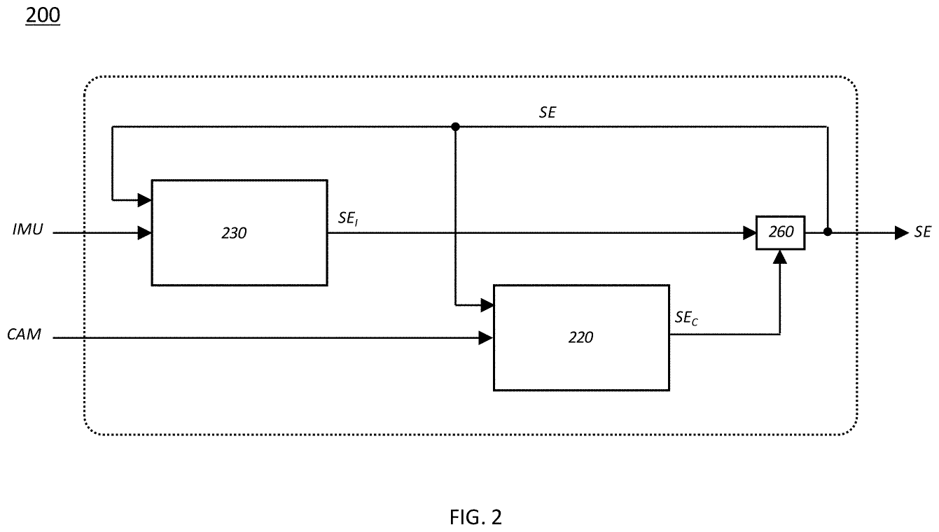

FIG. 2 shows a block diagram of a visual-inertial odometry system (200) that may be used for pose estimation of the aircraft of FIG. 1A based on fusion of information from the camera based sensor (1220) and the IMU sensor (1230) of FIG. 1B. Such block diagram may represent functional blocks (220, 230, 260) embedded in the control electronics of the gondola (120a) that are configured to generate a pose estimate, SE, of the gondola/aircraft based on information (e.g., IMU, CAM as indicated in the figure) sensed by the camera sensor (1220) and the IMU sensor (1230). Implementation of the functional blocks (e.g., 220, 230, 260) may be provided via, for example, software and/or firmware code embedded within programmable hardware components of the control electronics, such as, for example, a microcontroller or microprocessor and related memory, and/or a field programmable gate array (FPGA).

According to an embodiment of the present disclosure, pose estimation (e.g., SE as indicated in the figure) provided by the visual-inertial odometry system (200) shown in FIG. 2 may be based on a well-known in the art as such extended Kalman filter (EKF) that includes: a block (230) configured to perform a “a priori” step of the EKF based on the information, IMU, sensed by the IMU sensor (1230); a block (220) configured to perform a “a posteriori” step (e.g., also known as an update step) based on the information, CAM, sensed by the camera sensor (1220) of FIG. 1B; and an output register (260) configured to store the pose estimate, SE, for output. Further algorithms embedded in the control electronics of the gondola (120a) may take the pose estimate, SE, as input for navigation of the aircraft (120) inside of the container.

With continued reference to FIG. 2, the block (230, a priori step) receives the information, IMU, sensed by the IMU sensor (1230) and outputs an a priori pose estimate, SE_{I}, based on a well-known in the art as such recursive process that takes into account a current value of the pose estimate SE. The output register (260) receives a new value of the pose estimate, SE, equal to the a priori pose estimate, SE_{I}. Likewise, the block (220, a posteriori step) receives the information, CAM, sensed by the camera sensor (1220) and updates the output register (260) with a new pose estimate, SE_{C}, that is obtained through a recursive process based on the current value of the pose estimate, SE.

The a priori step provided through the block (230) may integrate a new input/update value, IMU, over an amount of time elapsed since a last input/update, and may calculate a new value of the pose estimate, SE_{I}, based on the current value, SE. On the other hand, the a posteriori step provided through the block (220) may take as input the current value of the pose estimate, SE, calculated by the a priori step; may predict/calculate a corresponding expected value of the pose estimate based on a new input/update, CAM; may generate a correction value based on a difference between the expected value and the current value of the pose estimate; and may update the value of the pose estimate, SE, to a new/updated value based on the correction value.

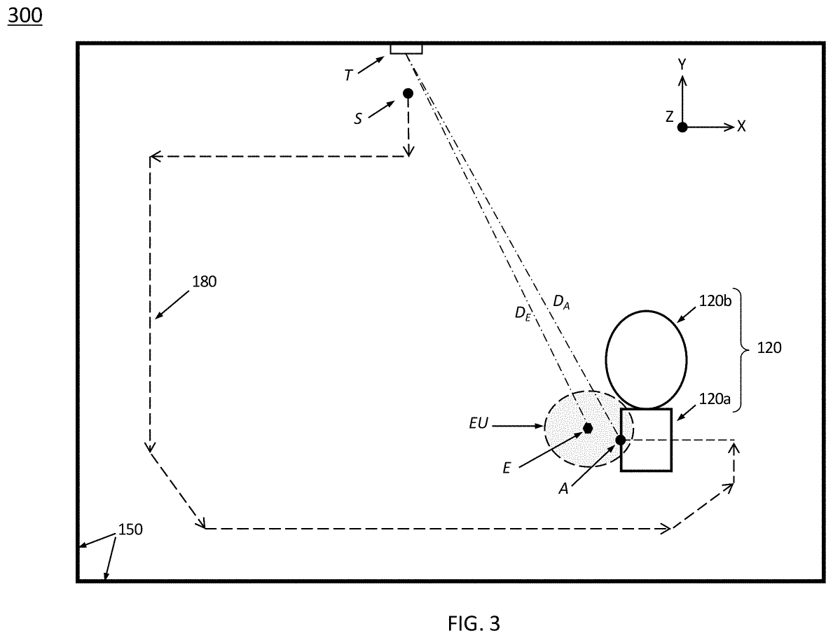

It should be noted that the two blocks (220, 230) shown in FIG. 2 may not operate at the same frequencies. In particular, as noted above, sensing via the camera sensor (e.g., 1220 of FIG. 1B) to provide/update the information, CAM, for use by the block (220) may be at a relatively low rate due to the overhead required in processing of the images captured by the camera sensor. On the other hand, sensing via the IMU sensor (e.g., 1230 of FIG. 1B) to provide/update the information, IMU, for use by the block (230) may be at a relatively high rate since very little or no processing of information sensed by the IMU sensor may be required. In other words, updating of the pose estimate, SE, based on the information, IMU, may be at a higher rate than updating/correcting of the pose estimate, SE, based on the information, CAM. As noted above, the relatively low rate of updates provided by the camera sensor (e.g., 1220 of FIG. 1B) combined with scarce image features detectable inside of the container, may limit improvement in accuracy of the pose estimate of the visual-inertial odometry system (200) of FIG. 2. A performance of such system as measured by uncertainty in position/location of the aircraft with respect to a position of a known (visual) target (e.g., T) is shown in FIG. 3.

In particular, FIG. 3 shows a diagram (300) depicting uncertainty in (an estimated) position (e.g., EU) of the aircraft (120) provided by the visual-inertial odometry system (200) of FIG. 2. A trajectory (180, e.g., shown in an arbitrary x, y, z coordinate space) that the aircraft (120) has traveled within walls (150) of the container (e.g. oil tank) may include a known start position, S, and a current estimated position, E. As shown in FIG. 3, the estimated position, E, of the aircraft (120) referenced to a known position of a target, T, represented by a distance, D_{E}, in the figure, may be located at a center of an uncertainty space/sphere, EU, that encompasses an actual position, A, of the aircraft (120, e.g., located at a distance DA from the target T).

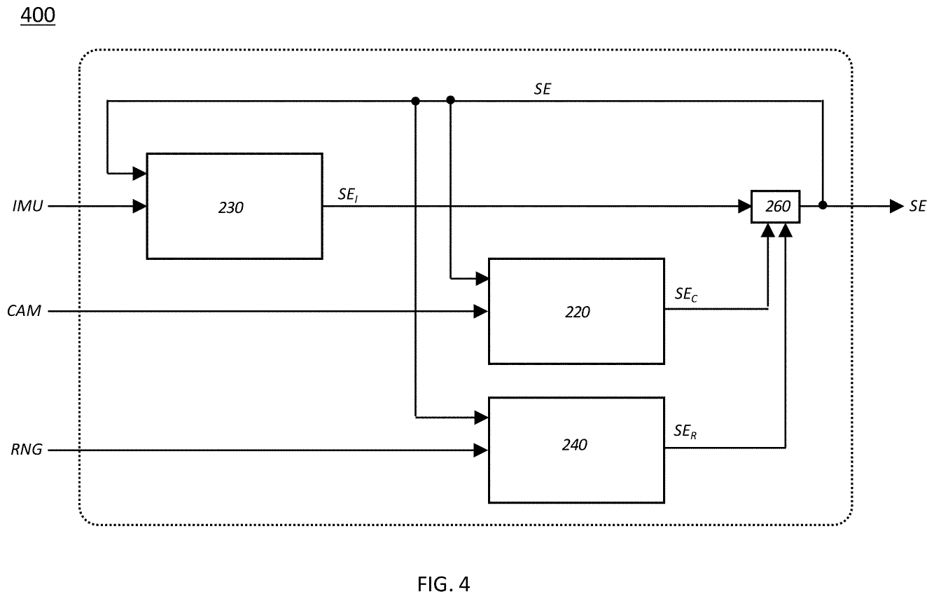

With continued reference to FIG. 3, a radius of the uncertainty sphere, EU, may be an increasing function of a time of travel/flight of the aircraft (120) through the trajectory (180). In other words, as noted above, the error in position estimate (e.g., encompassed within the pose estimate SE of FIG. 2) may drift with time of travel of the aircraft (120). Teachings according to the present disclosure fuse information sensed by the range sensor (e.g., 1240 of FIG. 1B) with information sensed by the camera and IMU sensors (e.g., 1220, 1230 of FIG. 1B) to reduce the uncertainty/error in the estimated position of the aircraft (120). As shown in the block diagram (400) of FIG. 4, this may be provided by modifying the visual-inertial odometry system (200) of FIG. 2 to include updates/corrections of the pose estimate, SE, based on information provided by the range sensor.

In particular, FIG. 4 shows a block diagram of a visual-inertial odometry system with range measurement (400) according to an embodiment of the present disclosure that may be used for pose estimation of the aircraft of FIG. 1A. Such block diagram may include functional blocks (220, 230, 260) of the EKF described above with reference to FIG. 2, with an added functional block (240) that is configured to perform an “a posteriori” step (e.g., update step) of the EKF based on the information, RNG, sensed by the range sensor (1240). In other words, in addition to the functionality of blocks (220) and (230) described above with reference to FIG. 2, the pose estimate, SE, shown in FIG. 4 is further corrected/updated (e.g., updated pose estimate SE_{R}) based on the (range) information, RNG, received by the (a posteriori) block (240) in a fashion similar to the update provided by the (a posteriori) block (220). This includes, for example, receiving by the block (240, a posteriori step) range information, RNG, sensed by the range sensor (e.g., 1240 of FIG. 1B) and updating the output register (260) with a new pose estimate, SE_{R}, that is obtained through a recursive process based on the current value of the pose estimate, SE.

It should be noted that update rates of each of the blocks (220, 230, 240) may be different, with expected higher rate for the block (230) as described above with reference to FIG. 2, and lower (and different from one another) rates for the blocks (220, 240).

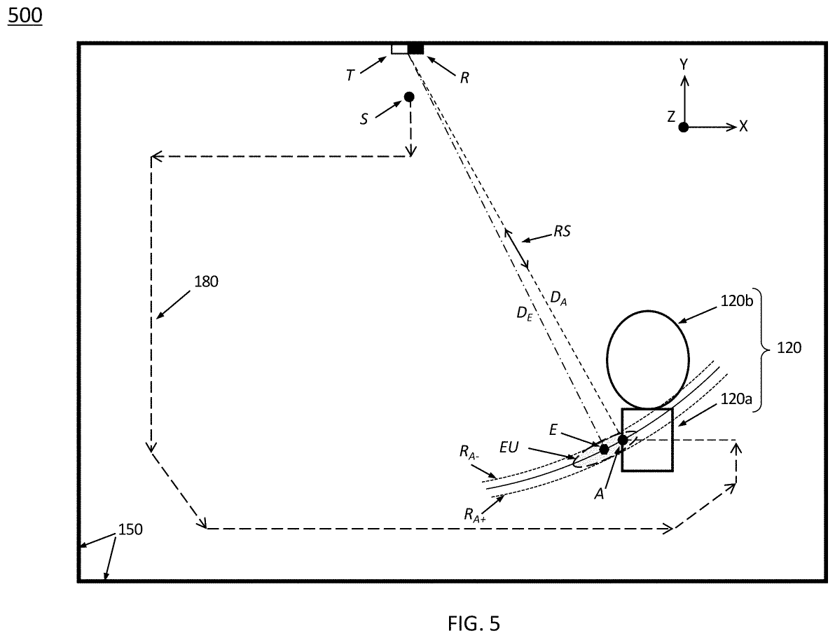

FIG. 5 shows a diagram (500) depicting uncertainty in (an estimated) position (e.g., EU) of the aircraft (120) provided by the visual-inertial odometry system with range measurement (400) of FIG. 4. According to an embodiment of the present disclosure, the range sensor (e.g., 1240 of FIG. 1B) senses a range (e.g. distance) to a reference range transmitter/receiver (e.g., R in FIG. 5) that is positioned/located within the inside walls (150) of the container at a fixed known reference position (e.g., R in FIG. 5). As shown in FIG. 5, the reference range, R, may be positioned at a known offset position with respect to the (visual) target, T. The visual-inertial odometry system with range measurement according to the present teachings (e.g., 400 of FIG. 4) may use a (known/absolute) position of the target, T, and a (known) position of the reference range, R, relative to the target, T, as coordinates of a (global) reference frame with respect to which a position of the aircraft (120) is predicted.

According to an embodiment of the present disclosure, the reference range R shown in FIG. 5 may be a UWB radio transmitter/receiver that is configured to communicate (e.g., two way communication signal RS of FIG. 5) with the range sensor (e.g., 1240 of FIG. 1B) attached to the aircraft (120) to derive a point-to-point distance between the reference range, R, and the range sensor. A person skilled in the art would know of different schemes to derive such distance, including, for example, based on a strength or a time of arrival of a signal received by the range sensor, or a based on two-way time-of-flight of a signal transmitted to the reference range, R, and received back to the range sensor. It should be noted that the range sensor (e.g., 1240 of FIG. 1B) may not be limited to an UWB type of radio sensor, as teachings according to the present disclosure may equally apply to other types of range sensors, including, for example, acoustic range sensors (and companion reference range R).

With continued reference to FIG. 5, communication, RS, between the aircraft (120, via range sensor 1240 of FIG. 1B) and the reference range, R, establishes a radial position of the aircraft with respect to a (fixed, known) position, R, of the reference range, R, that is solely bound by an uncertainty (e.g., R_{A+}, R_{A-}) in the provided range measurement. As shown in FIG. 5, range uncertainty may be bound by an upper radius, R_{A+}, and a lower radius, R_{A-}, of respective upper and lower spheres centered at the (known/fixed position of the) reference range, R. It should be noted that the uncertainty provided by the range measurement may be considered as measurement noise having a standard deviation defined by the upper/lower radii. As will be clearly understood be a person skilled in the art, the estimated position, E, provided by the visual-inertial odometry system with range measurement (400) of FIG. 4, may include an uncertainty space, EU, that as shown in FIG. 5 is bounded in a (radial) direction to the reference range, R, (i.e., point to point distance) by an amount that does not drift (e.g., fixed). In other words, the range sensor (e.g., 1240 of FIG. 4) provides an absolute constraint (e.g., with fixed/non-drifting uncertainty/error) in the visual-inertial odometry system with range measurement according to the present teachings.

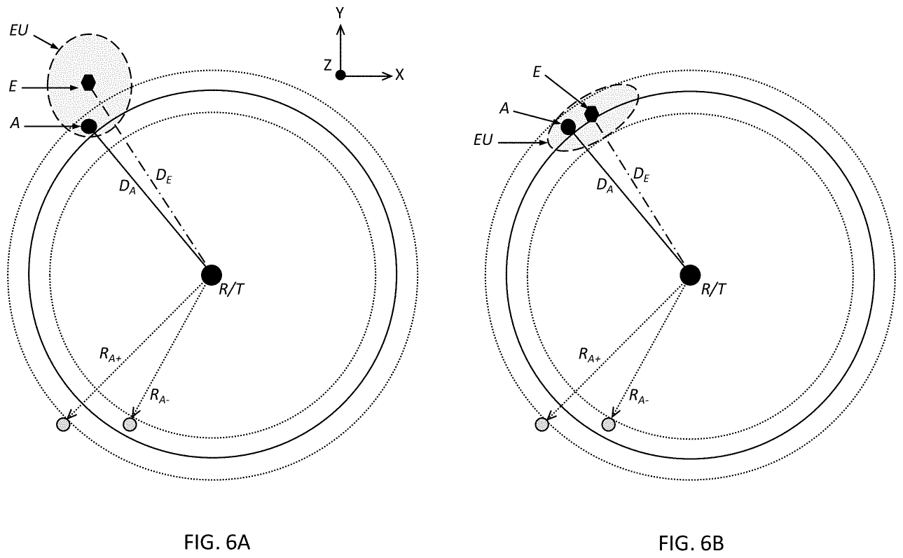

FIG. 6A and FIG. 6B show additional details of the uncertainty space, EU, respectively provided by the systems (200) of FIG. 2 and (400) of FIG. 4. As can be clearly seen in such figures, fusion of information from the range sensor as provided by the system (400) allows to further limit/reduce the uncertainty space, EU, that encompasses the estimated position, E, of the aircraft.

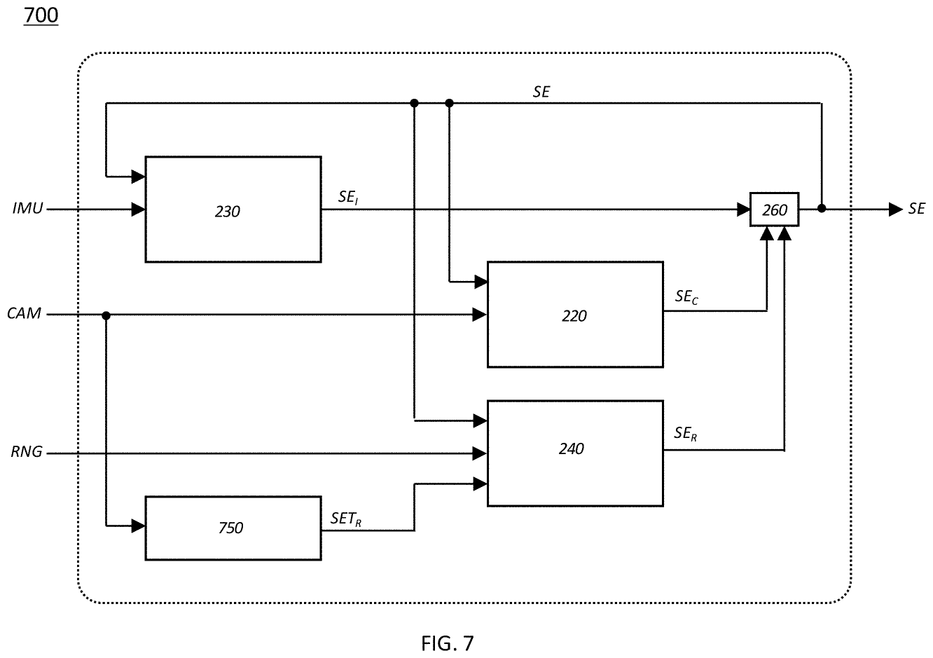

FIG. 7 shows a block diagram of a visual-inertial odometry system with range measurement (700) according to an embodiment of the present disclosure based on the block diagram of FIG. 4 with an added initialization step (e.g., functional block 750) for derivation of a (global) reference frame. As described above with reference to FIG. 5, coordinates of the reference frame may be provided by a (known/absolute) position of the target, T, and a (known) position of the reference range, R, relative to the target, T. According to an embodiment of the present disclosure, the known position of the target, T, may be used to initialize the reference frame by placing the target, T, in the field of view of the camera sensor (e.g., 1220 of FIG. 1B) at a start position of a traverse (e.g., known position S within the trajectory 180 of FIG. 5). At the same time, position of the reference range, R, with respect to the reference frame is determined by taking a range measurement (e.g., RNG) and further correcting based on the known offset between the position of the target, T, and the reference range, R. Synchronization of such tasks for derivation of the reference frame are provided by the frame initialization block (750).

With continued reference to FIG. 7, the frame initialization block (750) receives the information, CAM, from the camera sensor (e.g., 1220 of FIG. 1B) to determine/detect/signal presence of the target, T, in a field of view of the camera sensor. If the target, T, is detected, then the frame initialization block (750) sets a (set reference frame) flag, SET_{R}, to the block (240). In turn, when the flag, SET_{R}, is set, the block (240) reads the current pose estimate, SE, which includes (actual/absolute) coordinates of the reference frame and stores it as the reference frame, including corresponding range information, RNG.

In view of the above, it will be clear to a person skilled in the art that presence of the target, T, inside of the container is only required at the start of the traverse for initialization of the reference frame. According to an exemplary embodiment of the present disclosure, the start of the traverse (e.g., S of FIG. 5) may be at a top region/opening of the container where the aircraft (e.g., 120 of FIG. 5) may start its descent into the container. At that position, the target, T, may be presented to the aircraft for initialization of the reference frame, and removed from the container after the initialization. Although the target, T, may be of any shape, size and texture/content, according to an exemplary embodiment of the present disclosure, the target, T, may include coded information (e.g., quick response QR code or a visual fiducial system such as AprilTags®) that may be detected/decoded by the camera sensor and software and/or firmware code embedded within programmable hardware components of the control electronics of the gondola (e.g., 120a of FIG. 1B). It is noted that use of a fiducial system such as the AprilTags® may be advantageous due to its detection robustness to (low) lighting conditions and view angle.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A system for visual inspection of an inside of a container, the system comprising:
a reference range sensor arranged at a fixed location inside of the container; and
an aircraft configured for traversal through a trajectory inside of the container, the aircraft comprising a gondola attached to a balloon that is filled with a lighter-than-air gas, the gondola comprising:
a camera sensor;
an inertial measurement unit (IMU) sensor;
a gondola range sensor configured to be in communication with the reference range sensor, the gondola range sensor configured to sense an absolute distance between the gondola range sensor and the reference range sensor; and
control electronics configured to calculate a pose estimate of the aircraft during the traversal of the trajectory based on information sensed by the camera sensor and the IMU sensor, and further based on the absolute distance between the gondola range sensor and the reference range sensor.

2. The system according to claim 1, wherein:
each of the reference range sensor and the gondola range sensor is an ultra-wideband (UWB) radio transmitter and/or receiver.

3. The system according to claim 1, wherein:
each of the reference range sensor and the gondola range sensor is an acoustic transmitter and/or receiver.

4. The system according claim 1, wherein:
the control electronics comprises an extended Kalman filter that comprises:
an a priori block configured to recursively generate the pose estimate based on the information from the IMU sensor;
a first a posteriori block that is configured to recursively update the pose estimate based on the information from the image sensor; and
a second a posteriori block that is configured to recursively update the pose estimate based on the absolute distance between the gondola range sensor and the reference range sensor.

5. The system according to claim 1, wherein:
the control electronics is configured to calculate the pose estimate relative to a reference frame that is based on:
a known position of a visual target inside of the container, and
a known offset position of the reference range sensor with respect to the visual target.

6. The system according to claim 5, wherein:
at start of the traversal of the trajectory, the aircraft is configured to be oriented so that the visual target is positioned within a field of view of the camera sensor.

7. The system according to claim 6, wherein:
the visual target comprises a QR code.

8. The system according to claim 5, wherein:
at start of the traversal of the trajectory, the visual target is present inside of the container, and
during the traversal of the trajectory, the visual target is absent from the inside of the container.

9. The system according to claim 1, wherein:
the information sensed by the camera sensor is based on relative movement of features within a sequence of consecutive images captured by the camera sensor.

10. The system according to claim 1, wherein:
the features are a priori unknown features represented by slight changes in intensity of pixels in the sequence of consecutive images.

11. The system according to claim 1, wherein:
the inside of the container is dark.

12. The system according to claim 1, wherein:
the inside of the container includes some liquid.

13. The system according to claim 1, wherein:
the gondola further comprises a light source configured to assist with sensing of the information by the camera sensor.

14. The system of claim 1, wherein the container is an oil tank.

15. A system for pose estimation of an aircraft configured to navigate in a dark environment, the system comprising:
a camera sensor;
an inertial measurement unit (IMU) sensor;
a system range sensor; and
control electronics configured to:
calculate a pose estimate of the aircraft based on information sensed by the camera sensor and the IMU sensor, and
correct the pose estimate based on an absolute range sensed by the system range sensor.

16. The system according to claim 15, wherein:
the system range sensor is an ultra-wideband (UWB) radio transmitter and/or receiver.

17. The system according to claim 15, wherein:
the absolute range is based on a fixed location of a reference range sensor that is configured for communication with the system range sensor.

18. The system according to claim 17, wherein:
the control electronics is further configured to calculate and correct the pose estimate relative to a reference frame that is based on:
a known position of a visual target inside of the dark environment, and
a known offset position of the reference range sensor with respect to the visual target.

19. An aircraft configured for traversal through a trajectory inside of a container, the aircraft comprising a gondola attached to a balloon that is filled with a lighter-than-air gas, the gondola comprising:
a camera sensor;
an inertial measurement unit (IMU) sensor;
a gondola range sensor configured to be in communication with a reference range sensor external to the aircraft, the reference range sensor configured to sense an absolute distance between the gondola range sensor and the reference range sensor; and
control electronics configured to calculate a pose estimate of the aircraft during the traversal of the trajectory based on information sensed by the camera sensor and the IMU sensor, and further based on an absolute distance between the gondola range sensor and the reference range sensor.

20. The system of claim 19, wherein the container is an oil tank.
